(19) United States
(12) Patent Application Publication
(10) Pub. No.: US 2011/0258026 A1
(43) Pub. Date: Oct. 20, 2011

(54) ADVERTISING VIEWING AND REFERRAL INCENTIVE SYSTEM

(76) Inventor: Kevin Prince, Sandy, UT (US)

(21) Appl. No.: 13/086,292

(22) Filed: Apr. 13, 2011

Related U.S. Application Data
(60) Provisional application No. 61/324,270, filed on Apr. 14, 2010.

(51) Int. Cl. G06Q 30/00

(52) U.S. Cl. 705/14.16

(57) ABSTRACT

An advertising referral incentive system encourages users to interact with advertisements by providing payment to original users for interaction with advertisements and interaction by users referred by original users. The payment may be monetary and also entries into a jackpot. Advertisers may select users based on demographic information provided by users and pay for the users they reach.

### RELATED APPLICATIONS

The present application claims the benefit of U.S. Patent Application Ser. No. 61/324,270, filed Apr. 14, 2010, which is incorporated herein in its entirety by reference.

### BACKGROUND

1. Field of the Invention

The present invention relates to advertising. More specifically, the present invention relates to methods for the targeted delivery of advertising to consumers and viral referral advertising.

2. State of the Art

Advertisers desire to get their message to potential customers and clients, but often have difficulty cutting through the advertising clutter. It can be difficult to predict the next viral advertising success. Often, advertisers and their creative team are stuck trying to determine the lines between “not funny,” “funny,” and “offensive” or “interesting” or “not interesting.” Not funny and not interesting advertisements are likely to be ignored by many. Funny or otherwise interesting advertisements catch people's attention and help bring positive attention to the message. Offensive messages may bring negative attention and detract from the overall message. As the advertising noise increases, the “funny” or “interesting” area may shrink as the ad may need to stand out further.

Further, the advertiser has to worry about which channels reach the targeted demographics of the message. Mistargeted advertisements are not only inefficient, but also can annoy or frustrate the mistargeted viewers. On the other hand, researching the correct channel may take significant time, effort, skill and money, and actually reaching the correct demographic is often difficult. As such, advertisers often see a choice between a large broadcast that mistargets many viewers or a more targeted channel that requires more research and may miss a substantial part of the desired demographic. Thus, the advertiser has many obstacles to even become noticed by a desired demographic.

People, on the other hand, are so bombarded with advertisements that they have started ignoring useful information along with the mistargeted advertisements. Relevant information about their favorite products and services may be ignored because the amount of information in the channels experienced by people is overwhelming. Potential advantages, information or discounts may be ignored not because they are irrelevant, but because they are not able to rise above the advertising noise.

Thus, there is a need for advertisers to reach a relevant demographic and a need for people to be reached by advertisements for products and services which are relevant to them. Thus, more targeted advertising benefits both the advertiser and the viewer.

### SUMMARY OF THE INVENTION

It is an object of the present invention to provide an improved method and system for delivering advertising to consumers.

According to one aspect of the invention, the method and system may function as a viral referral advertising incentive system and method, thereby increasing the number of a desired demographic who are likely to see an advertisement.

According to another aspect of the invention, a central advertising service provides benefits to users who watch targeted ads. For each ad watched, a user may receive a portion of the payment paid by an advertiser to the central advertising service and/or an entry in a sweepstakes jackpot. A portion of the payment paid by an advertiser may also go into the jackpot, such that the jackpot grows until won by one of the users.

According to another aspect of the invention, an existing user receives a payment when a user referred to the service by the existing user watches targeted ads, thereby encouraging the existing user to refer friends and colleagues to the service and advertisements. Further, the existing user may be compensated for second and/or subsequent generation referred users (referred users of referred users referred by the existing user) who watch targeted ads.

According to another aspect of the invention, a user may fill out demographic information, which may be used to select the user for targeted ads. For rare or highly valued demographics, the system may verify the demographics through external database requests. These demographics allow users to receive useful, targeted information with less risk of mistargeted information.

According to another aspect of the invention, an advertiser may self-select estimated placement in an advertising queue for targeted demographics. As the number of users who drop out of the queue increase with the number of ads watched, the price of an ad in the queue may be reduced. Even if the price per view is not reduced, the total spend may be reduced due to the reduction in total users and thus total views.

According to another aspect of the invention, a user may select the location for viewing advertisements which may be most convenient for him or her. For example, some people may elect to watch targeted advertisements on their computer, where it is easy to order items online if an advertisement shows a product or service they desire. Others may wish to view advertisements on a mobile device, such as a “smart phone” or tablet computer, such as an IPAD (Apple Computer, Inc., Cupertino, Calif.). This allows a person to view advertisements while waiting or during other periods of time when convenient.

According to another aspect of the invention, the advertisements may be targeted at least in part based on location of the viewer. Thus, for example, the system controlling the advertisements may select advertisements to run based on the proximity of the user to the location of the store. Thus, for example, if a person is within 1 mile of a BEST BUY store, the an advertisement for BEST BUY may rise to the top of the queue.

According to another aspect of the invention, the viewer may be notified of an advertisement which is of particular relevance. For example, if a person comes within 1000 yards of a STARBUCKS, the viewer may get an alert, either text, a beep, etc., notifying the user of an advertisement relevant to their proximity. Likewise, the system could also notify a user of a coupon, promotion or discount or other “value add” for the viewer if they are within a desired distance of an advertiser. This may include allowing the advertiser to present a coupon which could be used on a mobile phone, etc. to present at the point of sale.

According to another aspect of the invention, a portion of the system could be configured to allow entities to become part of the structure in which they are eligible for rewards when people who have joined based on a referral from the entity can entitle the entity to obtain the chance to win prizes or to otherwise be rewarded for the viewing of its referrals. Thus, for example, an organization could encourage its members to become viewers and could be entered for prizes and the like based on the viewership patterns of its members. Likewise, business organizations could become viewers and receive targeted business to business advertisements.

According to another aspect of the invention, viewers could receive bonuses for referring advertisements to their friends. For example, a coupon accompanying an advertisement could increase in value based on the number of people with whom it is shared.

These and other aspects of the present invention are realized in an advertising incentive system and method as shown and described in the following figures and related description.

### BRIEF DESCRIPTION OF THE DRAWINGS

Various embodiments of the present invention are shown and described in reference to the numbered drawings wherein:

FIG. 1 shows a diagram of the interaction within an incentive advertising system;

FIG. 2 shows a hardware diagram of an embodiment;

FIG. 3 shows a diagram of server connections to external resources;

FIG. 4 shows a diagram of an embodiment of a server solution;

FIG. 5 shows a flowchart of a user experience;

FIG. 6 shows a flowchart of an advertiser experience;

FIG. 7 shows a screenshot of a user homepage;

FIG. 8 shows a screenshot of a verification and interest screen;

FIG. 9 shows a screenshot of a continue screen;

FIG. 10 shows a screenshot of a campaign queuing screen;

FIG. 11 shows a screenshot of an alternate embodiment of a user homepage;

FIG. 12 shows a screenshot of an alternate embodiment of a verification and interest screen;

FIG. 13 shows a screenshot of an alternate embodiment of a continue screen;

FIG. 14 shows a screenshot of a channel select screen;

FIG. 15 shows a screenshot of a campaign targeting screen;

FIG. 16 shows a screenshot of an advertisement frequency and cost screen; and

FIG. 17 shows a screenshot of a reporting screen.

It will be appreciated that the drawings are illustrative and not limiting of the scope of the invention which is defined by the appended claims. The embodiments shown accomplish various aspects and objects of the invention. It is appreciated that it is not possible to clearly show each element and aspect of the invention in a single figure, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The drawings and descriptions are exemplary of various aspects of the invention and are not intended to narrow the scope of the appended claims.

Reference to a computer readable medium may take any form capable of being understood by a computer, computer peripheral or causing execution of a program of machine-readable instructions on a digital processing apparatus. A computer readable medium may include a compact disc, digital video disc, magnetic tape, Bernoulli drive, magnetic disc, punch card, flash memory, integrated circuits, network storage, downloadable files or other digital memory device.

Many of the functional units described in this specification have been labeled as modules to show their implementation independence. Modules may be implemented as hardware circuits, programmable hardware or software for execution by processors. Software modules may be organized as objects, procedures or functions. However, executables of a module need not be physically located together, but may be separated and/or stored in different locations, which, when joined logically together, may form the module and achieve its stated purpose. An executable file or module may be a single instruction or many instructions and may be distributed over several different segments of code, programs or memory devices. Data may also be discussed and may be organized within any suitable type of data structure.

It should be noted that the word screen has been selected to represent a collection of information displayed to a user. While an informational screen may be displayed to a user on a physical display, a screen, as discussed herein, may be larger, smaller or equal to the size of a physical display.

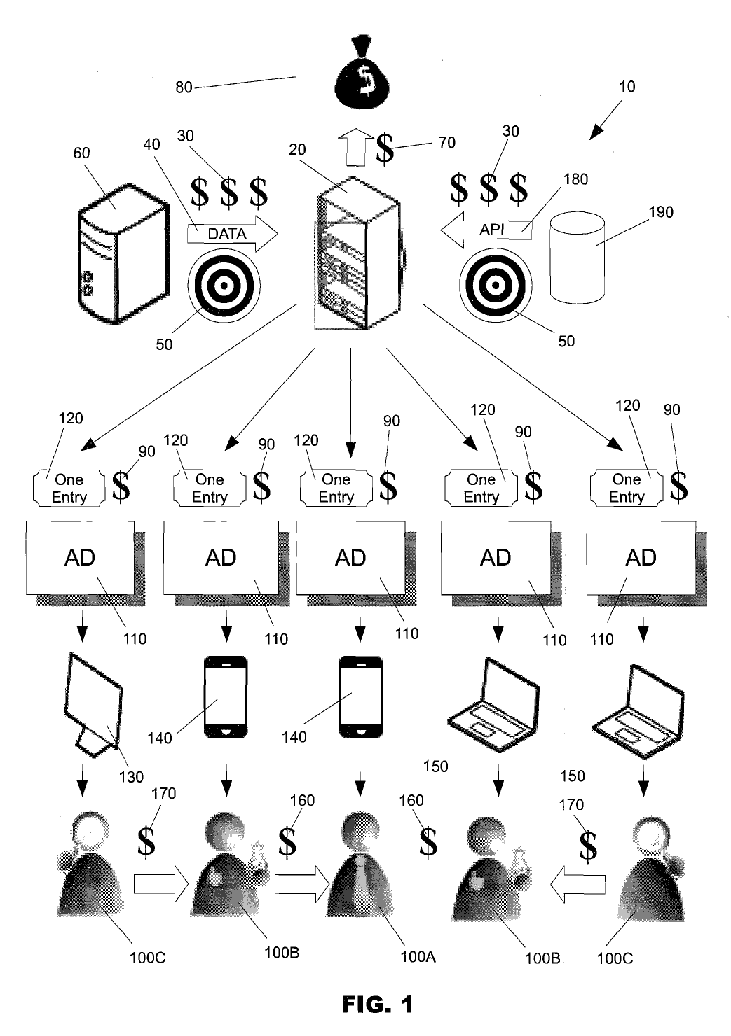

Turning now to FIG. 1, a diagram of the interaction within an incentive advertising system 10 or apparatus is shown. An advertising server 20 obtains information, which may include payment 30, information 40 (which may include the advertisement) and demographic target data 50 from an advertiser 60. A part of the payment in the form of a sweepstakes holdback 70 may be reserved for a sweepstakes jackpot 80. Other portions of the payment 30 in the form of user or viewer payment 90 may be paid to users (such as a first user 100A, a second user 100B, and a third user 100C) who watch an advertisement 110 created by the advertiser 60 and preferably focused on the users' 100A, 100B, 100C demographic. In addition to the user payment 90, the incentive advertising system 10 may include one or more sweepstakes entries 120 for the sweepstakes jackpot 80 for each advertisement 110 or group of advertisements watched by users 100A, 100B, or 100C.

It should be noted that the terms advertisement and advertising should be read to include both pushing and pulling information from a person receiving the advertisement. Thus, advertising should be read to include such things as a television commercial advertisement, advertisements, commercials, marketing material, sales material, surveys, pilot programs, infomercials, and other promotional information.

As an incentive to bring more friends, a user 100A may receive additional payments in the form of referral payments 160 for each advertisement 110 watched by a direct referral user 100B referred by the user 100A. The payments may be further cascaded such that a 2nd level referral payment 170 may be made to the user 100A who referred the direct referral user 100B who referred the 2nd level referral user 100C. While not shown, the referral levels may go deeper than a 2nd level referral user 100C to a 3rd level referral user and beyond.

Each user 100A, 100B, 100C may provide information about the user to the advertising server 20. The user 100A, 100B, 100C may provide demographic information, interests and self-select products or services that are interesting to the user 100A, 100B, or 100C. For more valuable demographics to advertisers, the demographic information may be verified through a third party. This information and selection ensures accurate information selected by advertisers and highly targeted ads to users. As the ads are more relevant, they may be more enjoyable to users and more effective for advertisers. The relevance may aid in both users 100A, 100B, 100C and advertisers 60 coming back more frequently. For example, a person who is an avid cyclist may be much more interested in watching advertisements for the sale of bicycles, bicycle components, helmets, sports nutrition products and magazines relevant to cycling. Such a person is also much more likely to purchase such products, making him or her a much more valuable viewer to a bicycle manufacturer than the public at large.

A different user, however, is likely to have different interests. For example, user 100A may be an avid cyclist, but his friend, user 100B may be an avid runner who does not care for cycling. Thus, she is more inclined to be interested in advertisements about running shoes, running magazines and half marathons than user 100A, while both may be interested in advertisements about sport nutrition, hydration etc. Thus, the advertisements shown to each viewer may be customized based on personal preferences.

Providing a user with multiple incentives solves many issues with advertisement clutter. The user 100A knows that he will be visiting a site with advertisements 110, and will feel less resistance to the advertisements 110 than if an advertisement was interrupting a favorite show. The user 100A has incentive to maximize his gain, and may likely invite referral users 100B who are likely to feel the same way. Further, the system invites participation because the user receives both a sweepstakes entry 120 for a jackpot payout and an immediate tangible benefit of user payment 90 and referral payments 160, 170. As stated above, the advertisements may be self-selected and/or related to current interests and therefore more relevant. In combination, the advertising service may be attractive to users 100A, 100B, 100C because of the monetary and emotional benefits described.

The user information may be used by advertisers 60 in their decision making process on an advertising campaign. In fact, the system may be further automated, such that an advertiser may connect an Application Programmer's Interface (“API”) 180 to the server 20. The API 180 may allow an advertiser system 190 to communicate through the API 180 to the server 20, and send the payment 30, information and demographic target 50 from an advertiser system 190 through the API 180. The API 180 may also return results to the advertiser. Thus, the advertiser system 180 may directly access advertising campaign information in their own system and remove the possibility of errors in retyping the information from the server 20 into their advertiser system 190. The campaign information may thus also be better tied to their internal systems to better calculate a Return on Investment (“ROI”).

The advertisement may be delivered through a device, including a television 130, mobile device 140, or computer 150. Once received, a user 100A may be required to validate the receipt of the advertisement 110. In some cases, a user may be required to perform one or more actions, such as a Turing test, CAPTCHA (an acronym for Completely Automated Public Turing test to tell Computers and Humans Apart), or quiz on the advertisement to prove the user 100A had seen the advertisement. In some cases, the test may ask substantive questions about the advertisement to show the user 100A had paid attention to the advertisement. (The ability of the user to recall information from the advertisement may also be highly valuable to the advertiser to insure that the advertisement is making the point desired by the advertiser.)

A mobile device 140 may include cell phones, smart phones, tablet computers and other wireless viewing/communications devices.

While a user may be generally considered to be a natural person, the system may also allow not natural persons, such as companies, charities, non-profits, for-profits and other associations, to receive the benefits of a user. In some embodiments, the associations may not watch advertisements directly. However, the associations may receive benefits for signing people up, jackpots, and the various levels underneath the company performing actions, such as watching advertising. By allowing associations to participate, more users may enter the system and the business may be rewarded for bringing the users to the system.

In one embodiment, advertising may also be targeted to associations or entities. Advertisers may thus have access to Business to Consumer (B2C) and Business to Business (B2B) advertising.

Those skilled in the art will appreciate that the server and the steps described above define an apparatus for presenting a plurality of targeted advertisements to a user and for providing a reward to the user for viewing the advertisement. The apparatus may be programmed with a payment module, information module (which may include the advertisement) and demographic target data module. The payment module may include information for payment in the form of a sweepstakes holdback reserved for a sweepstakes jackpot. Other portions of the payment module may include information of user or viewer payment to be paid to users (such as a first user 100A, a second user 100B, and a third user 100C) who watch an advertisement created by the advertiser. In addition the apparatus may include one or more sweepstakes entries for the sweepstakes jackpot for each advertisement or group of advertisements watched by users 100A, 100B, or 100C.

A computer readable medium is also presented to store a program that, when executed, performs one or more operations to formulate a computerized presentation of advertisements to a user and for providing a reward to the user for viewing the advertisement. The computer readable medium may be programmed with a payment module, information module (which may include the advertisement) and demographic target data module. The payment module may include information for payment in the form of a sweepstakes holdback reserved for a sweepstakes jackpot. Other portions of the payment module may include information of user or viewer payment to be paid to users (such as a first user 100A, a second user 100B, and a third user 100C) who watch an advertisement created by the advertiser. In addition the computer readable medium may generate one or more sweepstakes entries for the sweepstakes jackpot for each advertisement or group of advertisements watched by users 100A, 100B, or 100C.

It will also be understood that each of the steps described above can be performed as part of a method for displaying and incentivizing the viewing of advertisements. Preferably, the advertisements are targeted to the viewer so as to increase relevancy to benefit both the advertiser and the viewer.

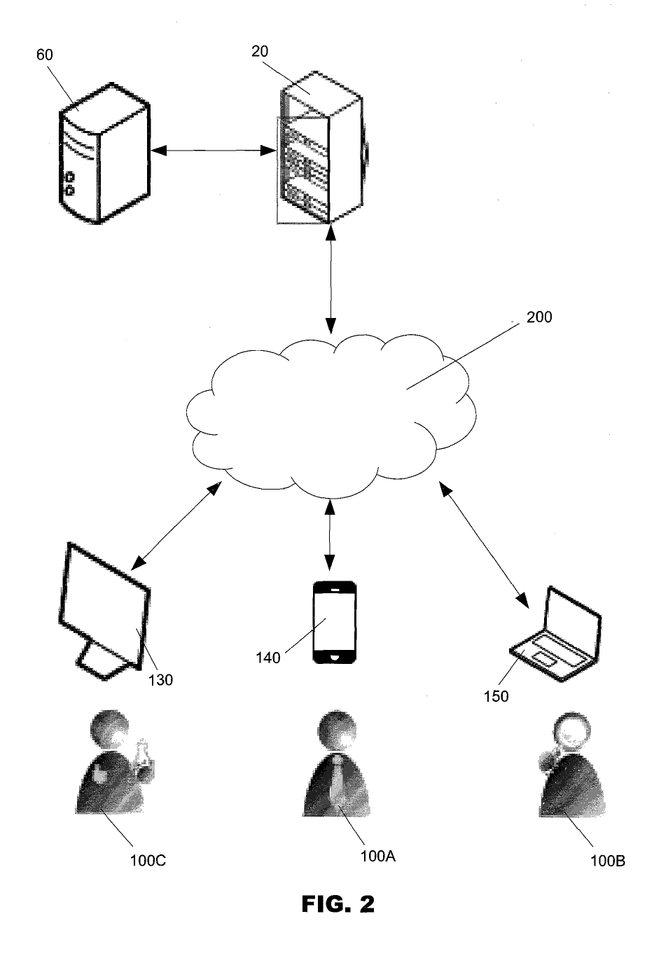

Turning now to FIG. 2, a hardware diagram of an embodiment is shown. It will be appreciated that the embodiment may be a system or apparatus and that the server may be or include a computer readable medium programmed to carry out the steps discussed below.

A user 100A with a mobile device 140 may connect through the internet 200 to an advertising server 20. Similarly, a referral user 100B with a computer 150 may connect through the internet 200 to an advertising server 20. Similarly, a 2nd level referral user 100C with a television 130 may connect through the internet 200 to an advertising server 20. The advertising sever 20 may receive instructions and advertisements from an advertiser 60 and match users 100A, 100B, 100C to advertisements. Once matched, the advertising server 20 may send the advertisements through the internet 200 to users' 100A, 100B, 100C devices, such as TV 130, mobile device 140 or computer 150.

Advertisements may also be delivered through cable, satellite or other broadcasting methods. A user viewing the advertisement may then connect to the advertising server 20 and verify receipt of the ad. The user may then be rewarded for viewing the advertisement, which may include enrollment in the jackpot and qualification for compensation.

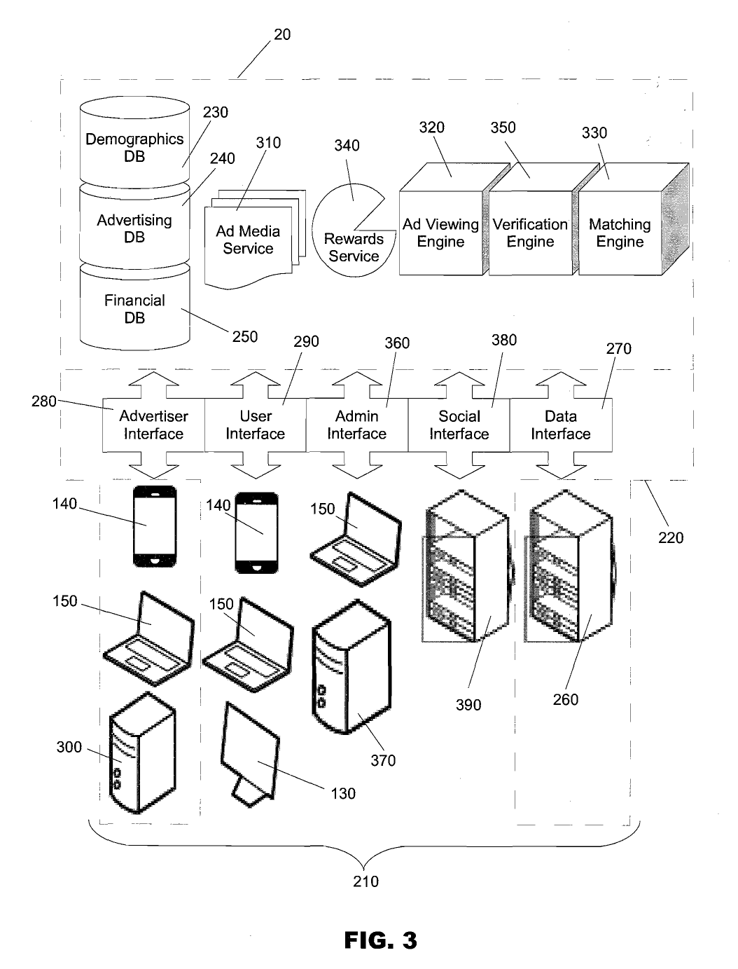

Turning now to FIG. 3, a diagram of server connections to external resources 210 is shown. The diagram may be viewed as a system or apparatus, as well as a computer readable medium which carries out the steps discussed below.

The server 20 may connect with external resources 210 through interfaces 220. Each interface may provide specific services, require different levels of authentication and disallow access to forbidden services.

The server 20 may include databases, engines and services. The databases may serve as storage and retrieval mechanisms. The engines may serve as decision logic and learning mechanisms. The services may provide connectivity to resources. In one scenario, an external resource 210 may connect to the server 20 through an interface 220. An engine may interpret the request, review data within a database with the information provided through the interface, and return a response based on a decision made by the engine based on the data. In some cases, the engine may choose to connect the external resource to a service.

The server 20 may have multiple databases. In one embodiment, the server 20 has a demographics database 230, advertising database 240 and financial database 250. The demographics database 230 may contain the information about each user 100A, 100B, 100C and summary statistics about the entire set of users and/or subsets of users.

In some cases, the demographics database 230 may be verified through a third party to certify an enhanced value to advertisers. For example, information on income, credit score, or other demographic information may be verified to confirm that the user is actually in the desired demographic. As such, the server may connect to a third party server 260 through a data interface 270. The server 20 may request confirmation of the user 100A, 100B, 100C information contained in the demographics database. Once confirmed, the server 20 may certify that demographic information to advertisers through the advertiser interface 280. In one embodiment, for example, advertisers may be willing to pay a premium to advertise to certified public accountants. As such, the server may request information from third party databases (such as LexisNexis™, Westlaw™, Government Licensing Databases, credit reporting agencies or other public or private databases). The information requested may be returned to the sever 20 through a data interface 270. After confirmation, the user 100A, 100B, 100C may be placed in a certified pool of certified public accountants in the demographics database. Such confirmation could take place in a wide variety of occupations, socioeconomic factors, or other information about a user to which an advertiser may wish to target an advertisement.

Certification may be advantageous for both the user and the advertiser. As certified, the user may receive more relevant advertisements, and the advertisements may contain a higher user payment 90. The advertiser may know that the advertisements are directed to confirmed members of the target market, making the value of having the advertisement viewed much higher.

The user interface 290 may provide a user 100A, 100B, 100C access to information related to her account. This information may include her demographic information, information about her referrals, account status, any payments and access to more advertisements.

The advertising database 240 may contain information related to advertising accounts and advertising account support. In one embodiment, the advertising database contains information about advertising campaigns. An advertiser may access the system through advertiser interface 280 and schedule campaigns and demographic targeting, including any rewards or incentives desired. Various campaign statistics may be reviewed, such as click-through, impressions, payout, ratings, daily limits, suggested daily limits, and user trends. The advertising database 240 may contain and/or store information provided and/or needed by the ad media service 310, ad viewing engine 320 and matching engine 330.

In some cases, the advertisers may access the system through an API call in the advertiser interface 280. The API call may allow an external server 300 to automate system advertising, rather than a person having to manually enter information into a web service.

The financial database 250 may contain financial information including information relating to payments, jackpots, earnings, rewards, costs, credits and billing. Thus, the financial database may provide information to users, such as amounts earned, amounts friends have earned, a list of referral users, number of jackpot entries, past winners, top earners and other information relating to the benefits received through the service. For advertisers, the financial database may provide cost breakdowns, invoices, credits, jackpot winner information, distribution information related to the payments, spending limits, current spend, and spend by demographic or other database filtering or selection criteria.

The system may also contain services, such as an ad media service 310 and reward service 340. The services may provide connectivity, delivery or other functionality related to the system. For instance, the ad media service 310 may provide delivery of advertisements. This may include delivery of video, surveys, interactive content or other advertising. It may also include delivery of the verification codes and content dictated by the verification engine 350.

The system may include a reward service 340. The reward service 340 may provide delivery of various incentives and payments. This may include jackpot entries, jackpot drawings, payments, purchase opportunities or other rewards.

The system may contain engines such as ad viewing engine 320, verification engine 350 and matching engine 330. The engines may provide services that include computational, transformative, integrity, verification or other data reviewing or mining services.

In one embodiment, the ad viewing engine 320 may be configured to provide the queuing of advertisements and ancillary products for users. The ancillary products may include processing user input such as preferences and ratings. The products may also include determining links, incentives or other methods to increase conversion for the targeted user in response to the advertisement.

The verification engine 350 may be configured to provide methods that verify and authorize user participation in the system. The verification engine 350 may verify the user viewed the content displayed or authorize rewards based on user verification. The verification engine may even provide external verification links on advertising outside of the system. In one embodiment, the system may require CAPTCHA, asking questions, playing an audio question which the user must answer, or requiring the user to interact with the system in some requested way such as clicking on a particular area of the screen. This interaction may insure that the user viewed the content and/or authorize the user for further rewards.

The matching engine 330 may be configured to provide methods that match users to advertisements. The matching engine may take user ratings, advertiser preferred demographics, and other demographic information and match advertisements to users. In some cases, this may estimate the number of users that may be reached in or costs for an advertising campaign. In other embodiments, the matching engine may prioritize advertisements to the most relevant users. In some embodiments, the matching engine may dynamically update the advertising choices based on user ratings or other input. This may improve the relevance of advertisements to the users.

The system may be controlled through an administrative interface 360. The administrative interface may allow an administrator to track and view activity on the website. This may include a dashboard summary of advertising campaign information, user information, site usage, revenue, payouts, trending and other information or summary statistics. The administrative interface may be directly accessed as a web page from a computer 150 or through an API by a server 370.

The system may also include a social interface 380 that allows the system to communicate with a social media server 390. In one embodiment, the system may enable a single account sign-on, such as from a FACEBOOK™ account. In another embodiment, personal statistics may be published to a blog or to status updates on a social media website. This provides not only the advantage of a single sign-on, but also allows the user to recruit referral users in a viral way.

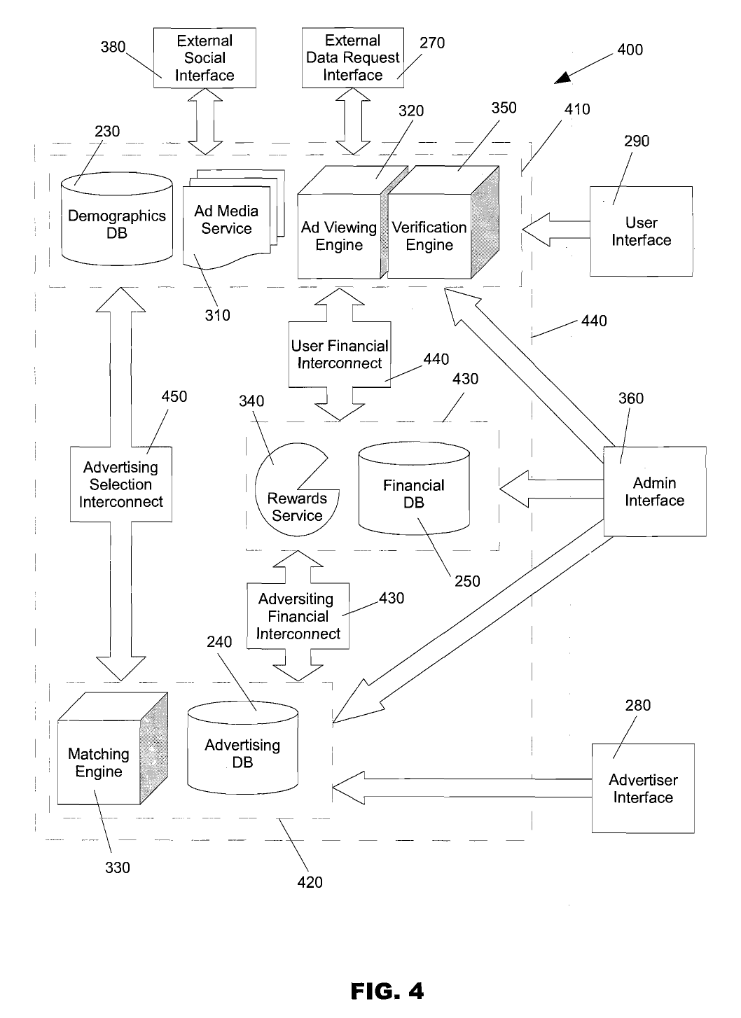

Turning now to FIG. 4, a diagram of an embodiment of a server solution 400 is shown. It will be appreciated that the diagram may be viewed as a system or apparatus, as well as a computer readable medium which carries out the steps discussed below.

The solution 400 may be sub-divided into a user module 410, an advertiser module 420 and financial module 430. While the modules are shown separated, and there may be distinct security advantages for separating the modules, it should be recognized that the modules may be combined or divided in other ways. Indeed, the databases, engines and services may reside on the same server or each one may be separated onto its own server. In fact, the databases, engines and services may be further sub-divided based on server load or demand. However, for the ease of describing the server solution 400, the databases, engines and services may be described as if within a cloud 440.

Within the cloud 440, the user module 410 may contain databases, services and engines relating to the user experience. In one embodiment, the user module 410 contains the demographics database 230, advertising media service 310, advertisement viewing engine 320 and verification engine 350. When needed, the user module 410 may request and store information within the financial module 430 through the user financial interconnect 440. Similarly, the user module 410 may request and store information within the advertiser module 420 through the advertising selection interconnect.

The interconnects 410, 420, 430 may allow the cloud 440 to isolate outside influence to the appropriate module and limit interaction to predefined methods. For example, the user module 410 may be the most exposed module. In one embodiment, the user module 410 is exposed via the external social interface 380, external data request interface 270 and user interface 290. These interfaces 380, 270, 290 may be weak due to the volume and sophistication of the users that must access the service. The weaknesses may include user issues such as weak passwords and shared passwords. The weaknesses may include public knowledge and generic access to the interfaces with little or no restriction. By separating the user module 410 from the financial module 430 and advertising module 420, the system may better maintain the security of the financial module 430 and advertising module 420. Even if the user module 410 is compromised, the financial module 430 and advertising module 420 may be isolated as they have specific defined access by the interconnects 440, 450.

Access to information may be limited by roles and interfaces. In one embodiment, an advertiser may only enter the system through the advertiser interface 280 and have access to the advertising module 420. On the other hand, an administrator may enter through the administrative interface and have access to all of the modules 410, 420, 430. However, the administrative interface may include more restrictions, such as ip address, browser, strong password or other identifying characteristics or security precautions.

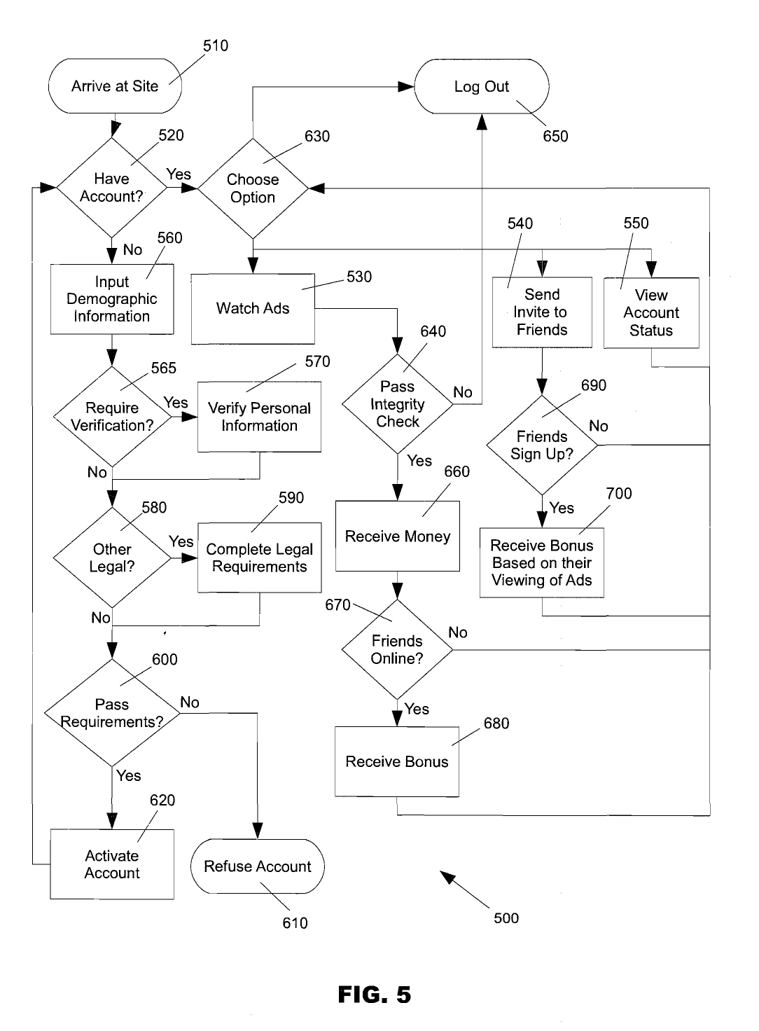

Turning now to FIG. 5, a flowchart of a user experience 500 is shown, and which define method steps of one aspect of the invention. Execution of the steps may be had by way of a system or a computer readable medium which presents the user experience to the user. In one embodiment, the user may select an account 520, watch ads 530, invite referrals 540 or view account status 550. These options may provide ways for a user to increase income and aid in the potential viral nature of the referral system among friends.

After arriving at the site 510, the user may select an account 520. If the user selects a new account, the system may request demographic information 560. If the demographic information is sufficiently important, the system may require verification 565 and verify the information 570 through third party databases. In either case, the system will then decide if further legal requirements are needed 580, such as parental permission or accepting the terms of service. If so, the requirements may be required to be completed 590. In any case, the system may then decide if the new user passes requirements 600, such as being beneficial to the system (i.e. not being a minor, being employed, having a low likelihood of fraud, not having a poor credit history, or other standards which may be desired by advertisers). If not beneficial, such as a high probability of fraud, the system may refuse the account 610. Otherwise, the system may activate the account 620. In some cases, the system may be invitation only, and one of the requirements may be an invitation confirmation to pass requirements 600.

Once logged in, the user may choose an option 630 to pursue. As one option, the user may choose to watch ads 530. After viewing the ad, the user may be required to pass an integrity check 640, such as a CAPTCHA, add a rating, complete a survey or questionnaire. The check may prove that the person has viewed the content and may qualify the user for payment. If failed, the user may be logged out 650 (in other systems the system may pause the system whereby they can replay the ad or go onto the next ad (without receiving credit for the first ad) instead of logging out). If passed, the user may receive payment 660 and other benefits such as options to click on actions such as ‘buy now”, link to advertiser website, learn more, download coupon, or get a promotional code. If referred friends are online 670, the user may receive a bonus 680 as an incentive for people to encourage their referrals to be online at the service, and to encourage the referring user to be online as well. In any case, the user may then make another choice 630.

The user may choose to send invitations to their friends 540 into join or log on the service. If friends sign up 690, the user may receive one or more of many different kinds of bonuses 700. There may be one time bonuses, reciprocal bonuses, extra entries, prizes, drawings or other incentives for those who succeed in referrals. In any case, the user may then make another choice 630.

In some cases, the user may choose 630 to look at account status 550 and update personal information, demographic information, award preferences, contact information, rewards, account balance, current interests, privacy settings, or other settings or information tied to the user. The user may also review their social network or other invitations, such that they may see those that have joined as a result of their referrals. The user may also review lists of winnings, including past and present winners.

In some embodiments, device location may be used in targeting and advertising delivery. A device may detect or be detected near a location through a location detection system. Once observed near a location, the system may offer an advertisement to view, coupons, promotion information, discounts or other potential value to the device user. In some embodiments, the system may use the notification features of the device. In one embodiment, the system may use the combination of location and time, such that an advertisement would only be shown for hours that the business would likely receive customers.

For example, the system may detect that a user is within one mile of a restaurant near dinner time. The system may send a notice to the user's mobile device, such as a smartphone. The notice may include a coupon for a discount on dinner, with an offer to view an advertisement for a free appetizer. If the user accepts, the values may be associated with the user's account and made available on the mobile device.

In some embodiments, the system may interact with the user through multiple channels of communication. These channels may include, but are not limited to, website, text messaging, multi-media messaging, email, phone and instant messaging. These communications may include status updates, level growth, winnings, jackpots and other communications described herein.

The value offered to the device user may be stored and/or accessed by the device. The system may save the value given to the user in a saved value system. This value may be from an offer sent by device location, rewards earned by the user in the past, or coupons accepted by the user. In one embodiment, the user may present the device at the point of sale and access the saved value system to redeem the value.

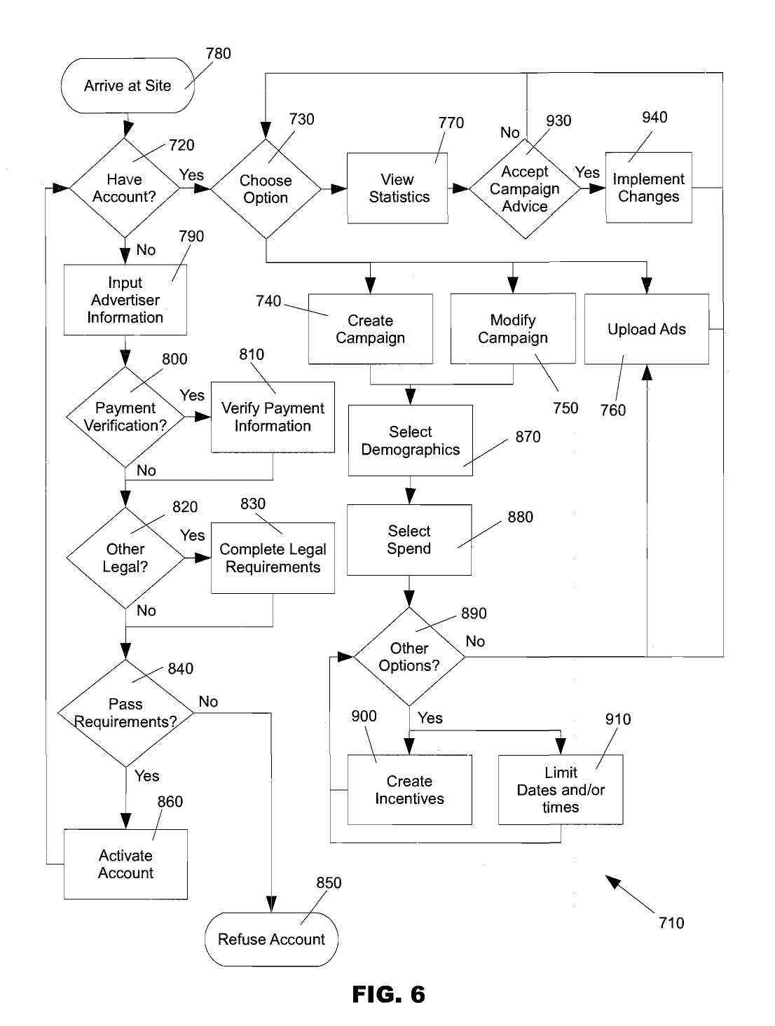

Turning now to FIG. 6, a flowchart of an advertiser experience 710 is shown and which defines method steps of one aspect of the invention. Execution of the steps may be had by way of a system or a computer readable medium which presents the advertiser experience to the user. In one embodiment, if the advertiser already has an account 720, the advertiser may choose an option 730 to create a campaign 740, modify a campaign 750, upload advertisements 760 or view statistics 770. These options may include tools to aid the advertiser to reach a desired demographic and measure the advertiser's success in influencing the desired demographic.

After arriving at the website 780, if the advertiser doesn't have an account 720, it will be prompted to create one. The advertiser will be prompted to input information 790, such as contact/profile information, some of which may be available to users. If the system requires a payment type on file, the user may be prompted to enter payment information. The system may further require verification of the payment method 800 to verify the payment method 810 is valid, non-fraudulent and the advertiser is serious about using the system.

If other legal requirements are needed 820, the system may aid the advertiser in completing the legal requirements 830. This may include accepting terms of service, providing terms for advertisers that choose to market to underage people or providing other specific disclosures, terms or agreements as may be required.

The system may then determine if the advertiser passes the requirements 840 for gaining access to the system. If not, the advertiser may be refused an account 850. If passing, the advertiser may activate its account 860. Activations may include a manual review, credit check, DUNN AND BRADSTREET™ report check or other external request to confirm information about the advertiser.

In some cases, accounts may be linked such that two or more advertisers may view or edit campaigns of another, depending on the permissions. This may prevent duplicative campaigns from running. This may also allow a company and an advertising agency to work together on the system. In one embodiment, this linking may be done through an invitation system.

Once the advertiser has an account 720, the advertiser may login and choose an option 730. The create campaign 740 or modify campaign 750 options may lead through similar steps, but operate on a new or existing campaign. The campaign target demographics may be selected 870 in combination with a desired spend 880. While selecting demographics, the system may give an estimate of cost based on the number of people in the target market along with the priority or placement of the advertisement selected. This estimate may be capped at an amount if desired.

The advertiser may select further options 890, such as creating incentives 900 or limiting dates and/or times 910 and/or the frequency of the ad display. The advertiser may create further incentives for paying attention to the advertisements or further interaction with the user. This may include website links, special offers, bonus money or jackpot entries for further participation, or other offers or interaction beyond the advertisement. The advertiser may also choose to run a campaign for a set time frame, such as a run-up to an event. In some cases, the advertiser may desire to limit the advertisement to certain hours. This time restriction may be useful for advertisers who know their target demographic. For example, the advertiser may want to target teenagers after school, such that the advertiser may limit the hours to between 4 pm and 9 pm on school days.

In some cases, the advertiser may desire to limit the frequency to specific days of the week. In some cases the advertiser may desire to specify the number of advertisements played to an individual user in a single day. In some cases the advertiser may desire to specify the number of other advertiser ads or the time between the display of their ad to the same user. For example, the advertiser may specify that they would like to show a maximum of 5 ads to the same user on a given day but that those ads must be separated by 10 other ads or by 30 minutes before playing again. The advertiser may then upload ads to the campaign 760 or return to choose another option 730.

The advertiser may select to view statistics 770 on its campaign or overall account. When selected, the advertiser may view statistics 770 in various forms. In one embodiment, the advertiser is shown a dashboard of summary statistics. The advertiser may further drill down to individual statistics in an attempt to determine causes for larger trends. In some cases a matching engine may provide campaign advice 920. This may be gathered from user reviews, click-through or other analysis of user interaction or other data. If the advertiser accepts the campaign advice 930, the system may automatically implement the suggested changes 940.

It should be recognized that steps may be performed out of order. In one embodiment, when creating a campaign or modifying a campaign, the user may be required to upload the advertisement 760 before selecting the demographics.

In one embodiment, the advertisements may require system administrator approval before the advertisement is allowed in a rotation.

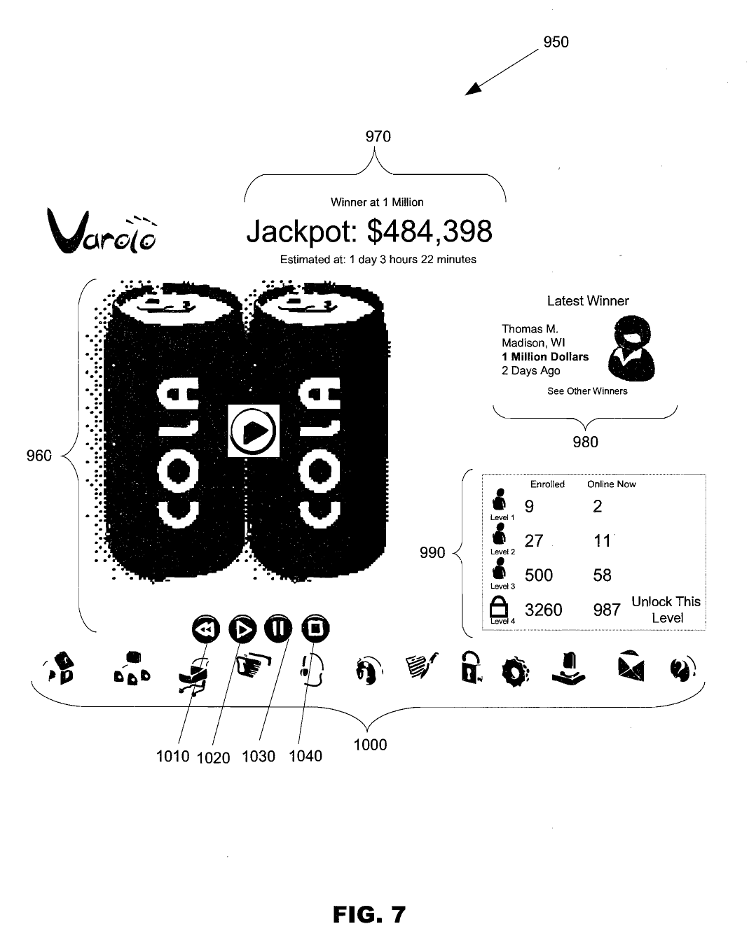

Turning now to FIG. 7, a screenshot of a user homepage 950 is shown. After a user logs in, the user may be presented with a user homepage 950. The homepage may contain an advertisement display 960, jackpot or other rewards display 970, winner display 980, summary statistics 990, profile display, current interests display, social network display and navigation bar 1000.

When arriving at the home page, the user may be presented with information encouraging further participation. The jackpot display 970 may provide large dollar values encouraging those interested in more jackpot entries. The winner display 980 may show real people who have won real money and/or prizes. The summary statistics display 990 may show further progression benefits that may encourage the user to perform further tasks. This may include recruiting more referrals, spending more time with advertisements or other desired tasks to unlock benefits.

The profile display 985 shows summary information about the users current jackpot or reward entries and compensation. The Current interests display shows topics that the user is interested in at this time in their life in the hope advertisers will present ads within these topics. The social network display shows the number of directly or indirectly referred users to the system with a display showing compensation being received through this network.

The advertisement display 960 may include controls such that the user may rewind 1010, play 1020, pause 1030 or stop 1040 advertisements. In one embodiment, the fast-forward button is disabled to prevent people from skipping portions of the advertisement. In another embodiment the fast-forward button is enabled after pressing rewind 1010, but only up until the point where the rewind started. If the ad is uninteresting, the user may hit stop 1040 instead of fast-forwarding.

The navigation bar 1000 may provide access to settings and tools to aid the user in watching advertisements, verifying the viewing of advertisements, authorizing payment and gaining referrals. This may include settings and tools relating to internet speed for smooth video for watching advertisements. This may include code entry screens for verifying the viewing of advertisements. This may include CAPTCHA screens for authorizing payment for having watched advertisements. This may include importing and emailing of contact lists to aid in the viral spread of the system among friends and other referrals.

It will be appreciated that the images shown to the user will typically be generated by the system, apparatus or computer readable mediums described above so that the entity controlling the server(s) is controlling the information viewable by the user.

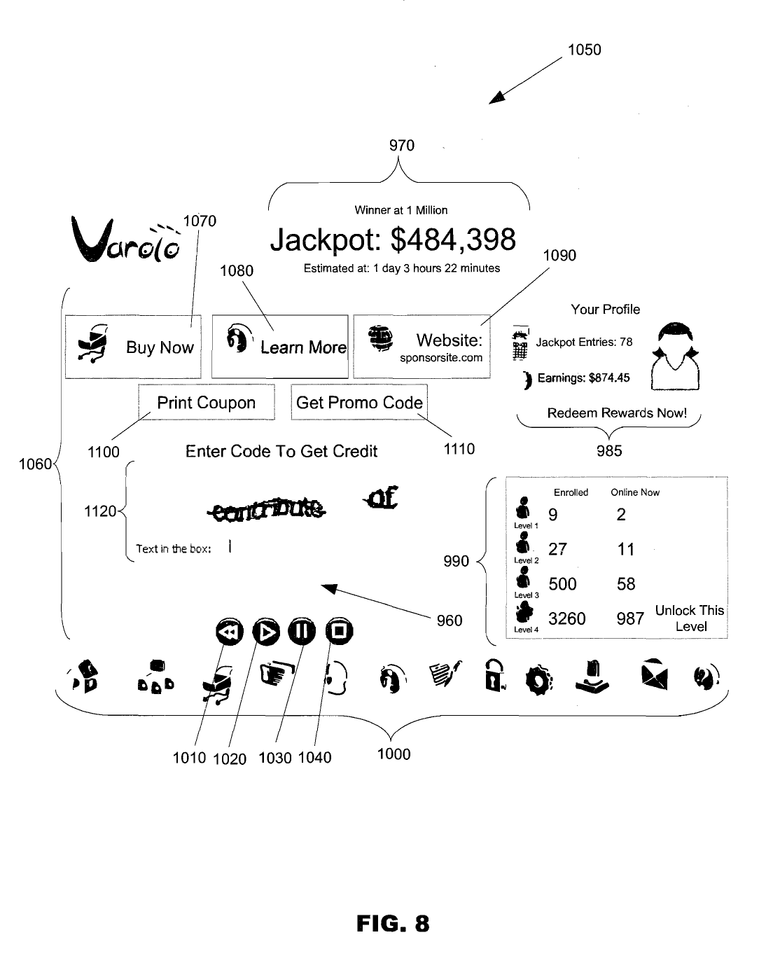

Turning now to FIG. 8, a screenshot of a verification and interest screen 1050 is shown. After viewing the advertisement, the advertisement display 960 may be overlayed or replaced by a verification and interest window 1060. The user may be presented with options relating to the advertisement. The user may be presented with a purchase button 1070, product landing page link 1080, sponsor website link 1090, coupon offer 1100 or even promotion code 1110. Each of these links may be tracked and presented to the advertiser as statistics, helping an advertiser understand the most effective offers. In one embodiment, the system allows the advertiser to rotate the offers to determine the most effective offer. In another embodiment, the system rotates the offers, but shows the offers that receive the most clicks with priority. Priority may include positioning of the offer or exclusion of other offers to reduce advertising clutter.

The verification and interest window may also include a verification component 1120 to verify viewing of the advertisement and/or authorize the disbursement of a reward for viewing the advertisement.

A configurable side display 985 may show different information depending on the context or configuration. One configuration, as a profile display, may show summary information about the users current jackpot or reward entries and compensation. Another configuration, as a current interests display, may show topics that the user is interested in at this time in their life in the hope advertisers will present ads within these topics. A social network configuration may show the number of directly or indirectly referred users to the system including compensation being received through this network.

The coupon offer 1100 may include a social discounting aspect. By sharing the coupon, the coupon value may increase for the original user. In some cases, the coupon value may increase to the full value of the product or service. The incentive for sharing the coupon and receiving a greater value may aid the coupon to be frequently shared, even viral. The system may provide this functionality with a social discount module.

The system may detect sharing in different manners. In one embodiment, the system may give greater coupon value for email addresses shared, status postings or other actions. In another embodiment, the coupon value may increase for purchases using a shared coupon. The system may also give greater coupon value for referrals accessing a coupon or advertisement, such as by a link.

For example, a user may be given a 20% discount. The discount may increase by 5% if the user posts the coupon to a social site, such as Facebook. If 20 people use the coupon in checkout, the coupon value may increase to a total of 50% off the purchase price.

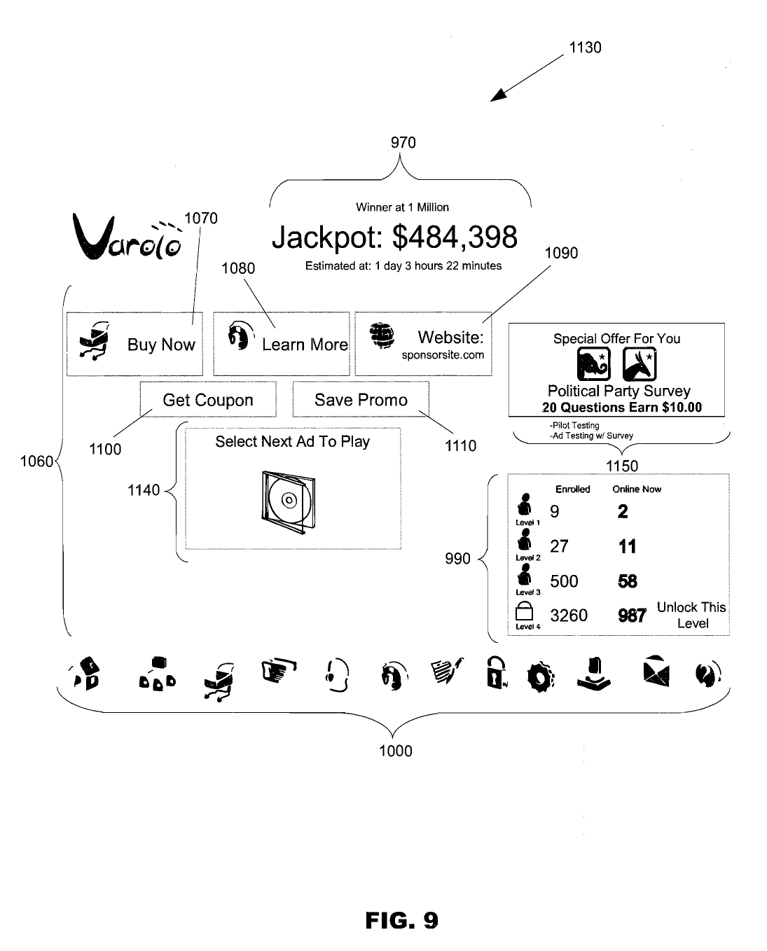

Turning now to FIG. 9, a screenshot of a continue screen 1130 is shown. Once the verification process is complete, the user may be invited to view more advertisements or receive other recommendations. In the embodiment shown, the user is invited to watch more advertisements in the advertisement selection display 1140. The user has also been selected to participate in a survey through an additional offer display 1150. Each of these offers may be driven by advertiser demographic selection, the matching engine or other target market identification and selection.

In addition to advertiser selection, the users may self-select advertisements through explicit requests, surveys and advertisement ratings. Thus, if a user selects a preference for automotive advertisements or answers in a survey that they plan to purchase a car, a dealership or car manufacturer may target this audience. In fact, these users may command a premium as they may be a more desirable market.

User ratings may also aid in advertising frequency. Advertisements with higher ratings may appear more frequently than advertisements with lower ratings. In one embodiment, advertisement bids are combined with ratings to determine priority of advertising placement. Thus, an unpopular ad for incontinence may still be shown with priority, but the advertiser must provide more value to the system. The value may come from an increased payout to the user, entry in a special jackpot, or more entries in a general jackpot. These bonuses may actually aid the advertiser in attracting further interest in an embarrassing or unpopular, but needed product.

In one embodiment, the system may also accept more detailed feedback on advertisements. After the advertisement has completed, the system may solicit feedback from a user. The user may be able to submit information about the advertisement, company, service and/or product. A user feedback submission may include text, audio and/or video.

The feedback may then go to the advertiser. The advertiser may choose to review the feedback. If the advertiser desires, the advertiser may also approve the feedback to be shown after the advertisement. Once approved, the feedback may appear for users to view after the advertisement completed. In one embodiment, the advertiser may choose to selectively enable or disable the feedback option, such that only specific advertisements may receive feedback.

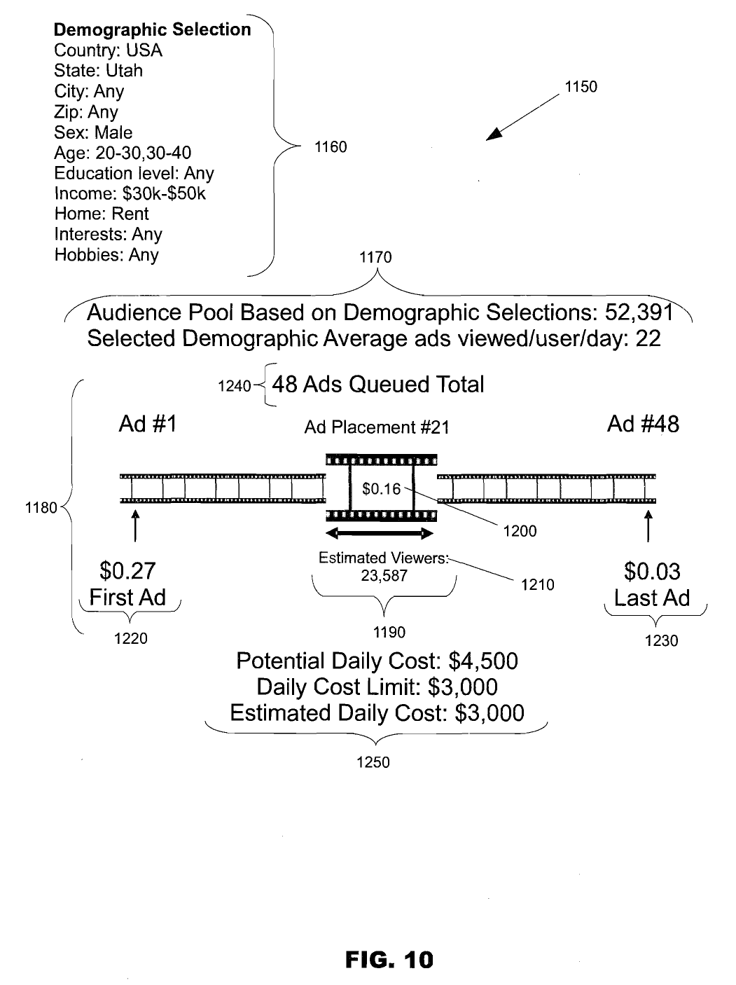

Turning now to FIG. 10, a screenshot of a campaign queuing screen 1150 is shown. Once an advertiser creates a campaign, the advertiser may select target demographics. This selection may be aided by the matching engine. After selecting the demographics, the advertiser may encounter the campaign queuing screen 1150. The selected demographics may be shown in a demographic display 1160. Based on the selected demographics, the matching engine may query the demographic database and display selected statistics. In the embodiment shown, the statistics are shown in a demographic display 1170, with the statistics as to how many users are in the demographic pool and average number of advertisements viewed per user per day.

Based on the number of ads in the system, the advertisers may bid for placement in the advertising queue 1180. The advertiser may adjust the placement of the current campaign using the queue slider 1190. The slider 1190 may display the current cost 1200 and estimated number of viewers of the advertisement 1210. In the event the advertiser desires to present the advertisement multiple times to the same user in one day, multiple indicators for ad queue placement may be shown. The advertising queue may aid the selection of the placement of the slider by a first ad cost display 1220, last ad cost display 1230, total queue length 1240 and estimated budget display 1250. The advertiser may thus decide the reach versus cost by adjusting the slider and capping the daily spend.

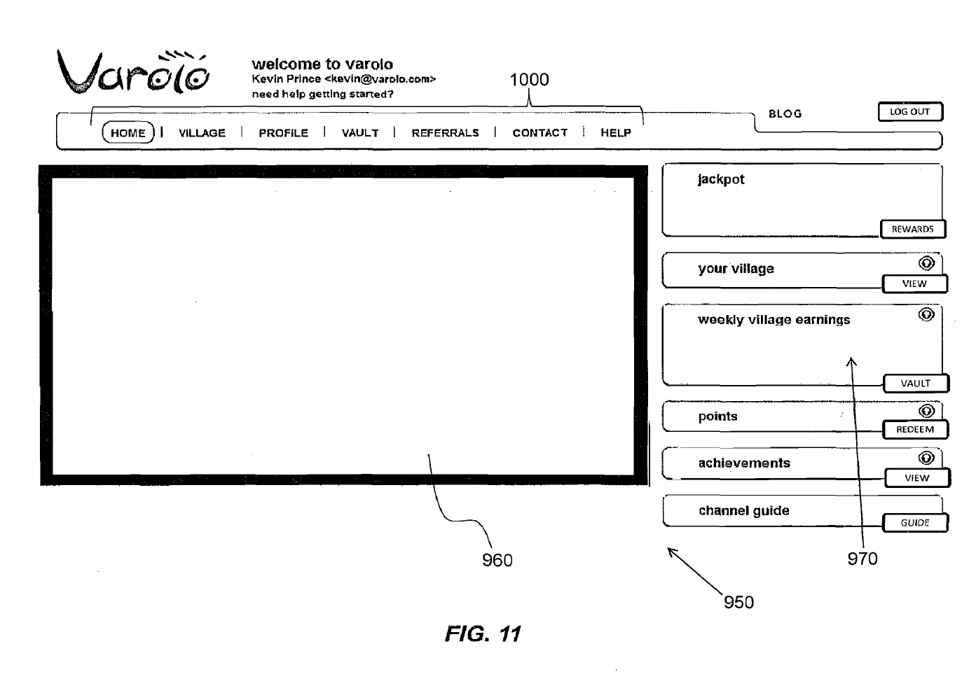

Turning to FIGS. 11 to 17, an alternate embodiment of screens are shown.

Turning now to FIG. 11, a screenshot of an alternate embodiment of a user homepage is shown. Similar to FIG. 7, after a user logs in, the user may be presented with a user homepage 950, with advertisement display 960, rewards display 970 and navigation 1000.

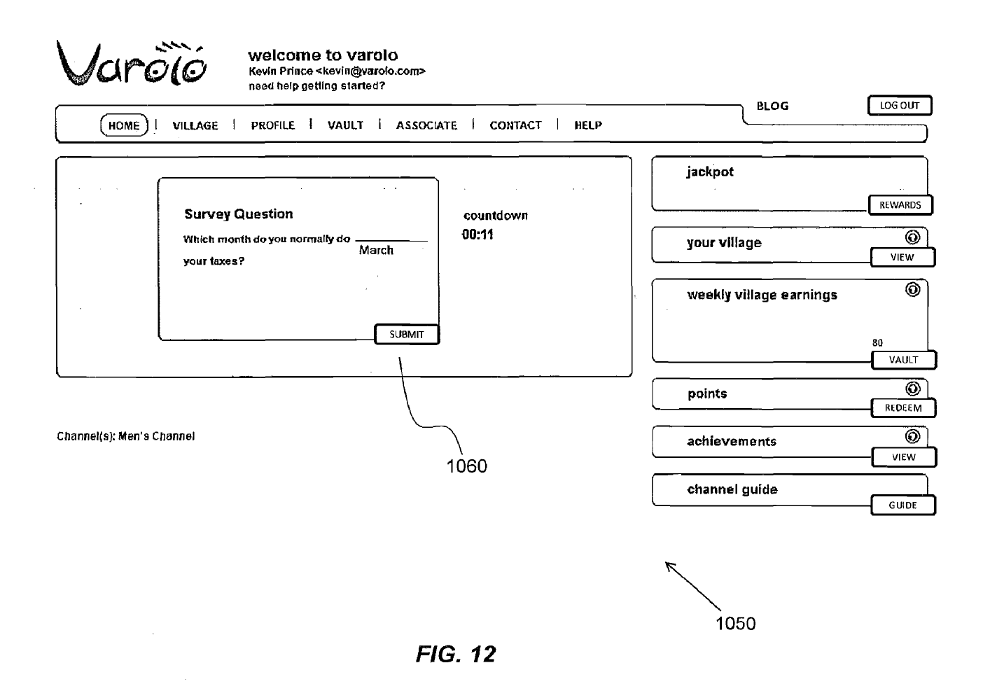

Turning now to FIG. 12, a screenshot of an alternate embodiment of a verification and interest screen 1050 is shown. After the advertisement has been shown, a user may be presented with a verification and interest window 1060. In one embodiment, the verification setting is optional, such that an advertiser may choose to not require a user to perform a challenge if desired.

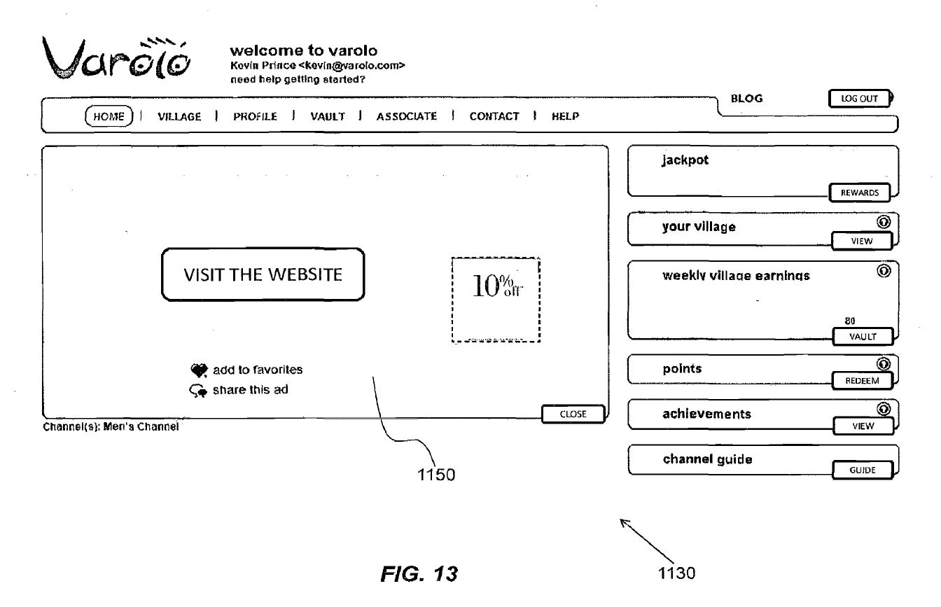

Turning now to FIG. 13, a screenshot of an alternate embodiment of a continue screen 1130 is shown. When the verification process is complete, the user may be presented with an additional offer display 1150, which may present to the user a coupon, a special offer, the ability to visit a website, etc. or to close the window and watch more advertisements.

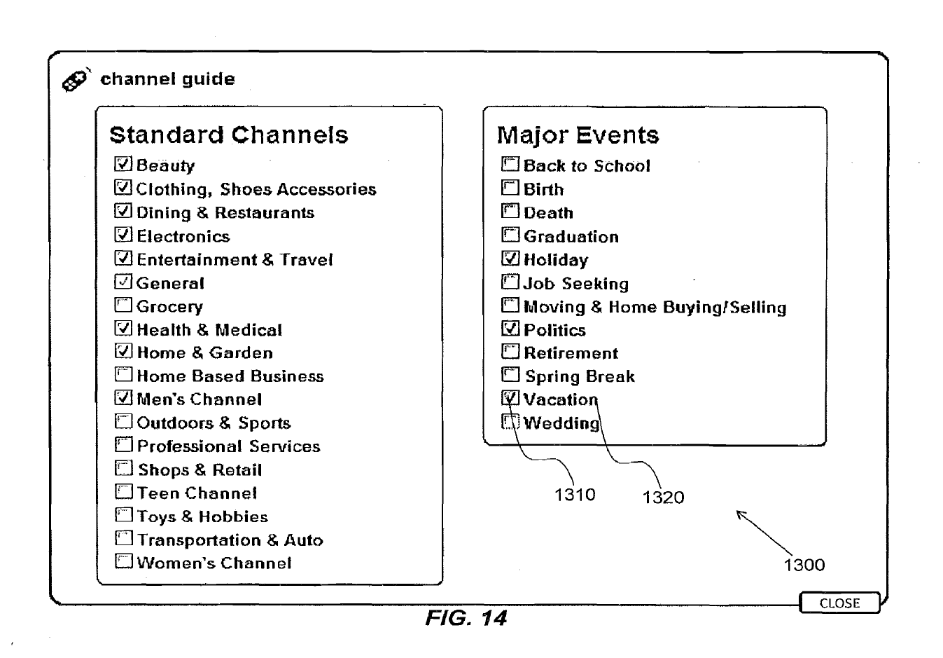

Turning now to FIG. 14, a screenshot of a channel select screen 1300 is shown. A channel select screen may allow a user to select their advertising preferences in order to allow a user to customize what the system displays for their viewing. These may include major life events, seasonal promotions, or various subject matters, such as back to school, birth, death, graduation, holiday, job seeking, home purchase or sale, politics, retirement, spring break, vacation, wedding, etc. as shown in FIG. 14. In the embodiment shown, a user may click a checkbox 1310 next to a desired subject 1320. These preferences may then be recorded and used in the decisions of what advertising to show a user.

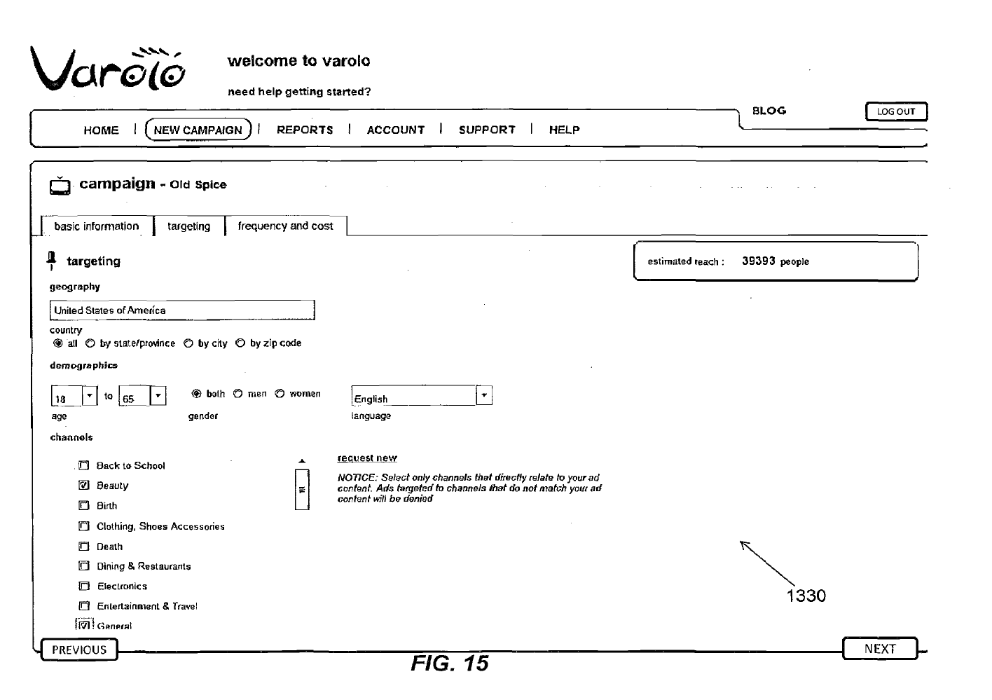

Turning now to FIG. 15, a screenshot of a campaign targeting screen 1330 is shown. An advertiser may select geographic, demographic and psychographic profiles of a target audience. An advertiser may also select channels that represent the content of the advertisement.

In one embodiment, this screen represents the second step of creating an advertisement after the first step of uploading the content.

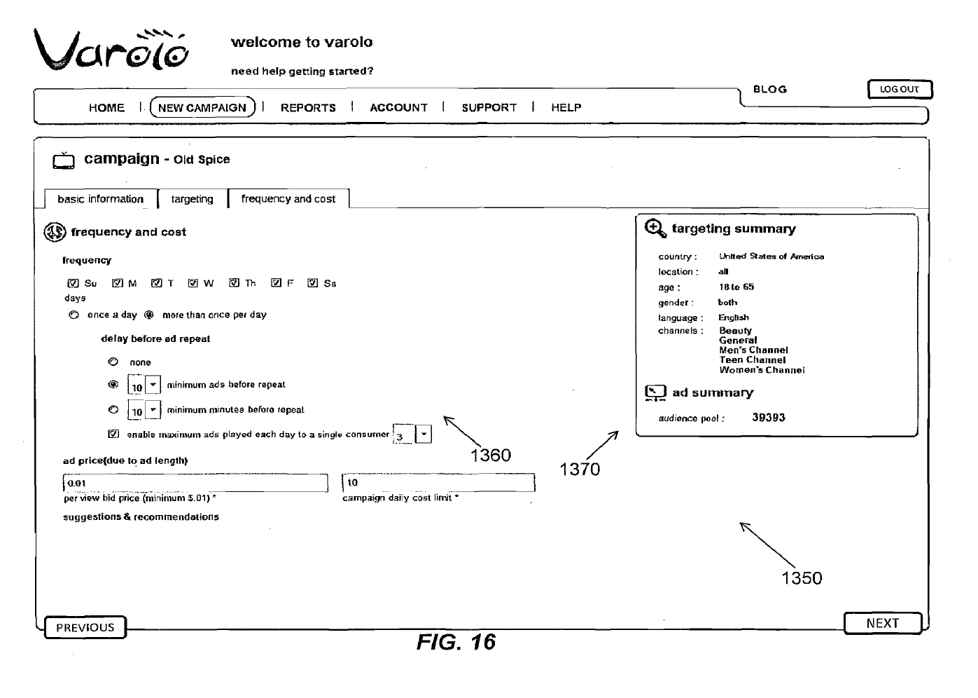

Turning now to FIG. 16, a screenshot of an advertisement frequency and cost screen 1350 is shown. An advertiser may choose frequency, timing and cost from a form 1360 such as days of the week, the ability and timing of the repetition of the advertisement, and bid price. The system may display resulting information 1370, such as advertising costs, reach and other metric estimates based on the information given by the advertiser.

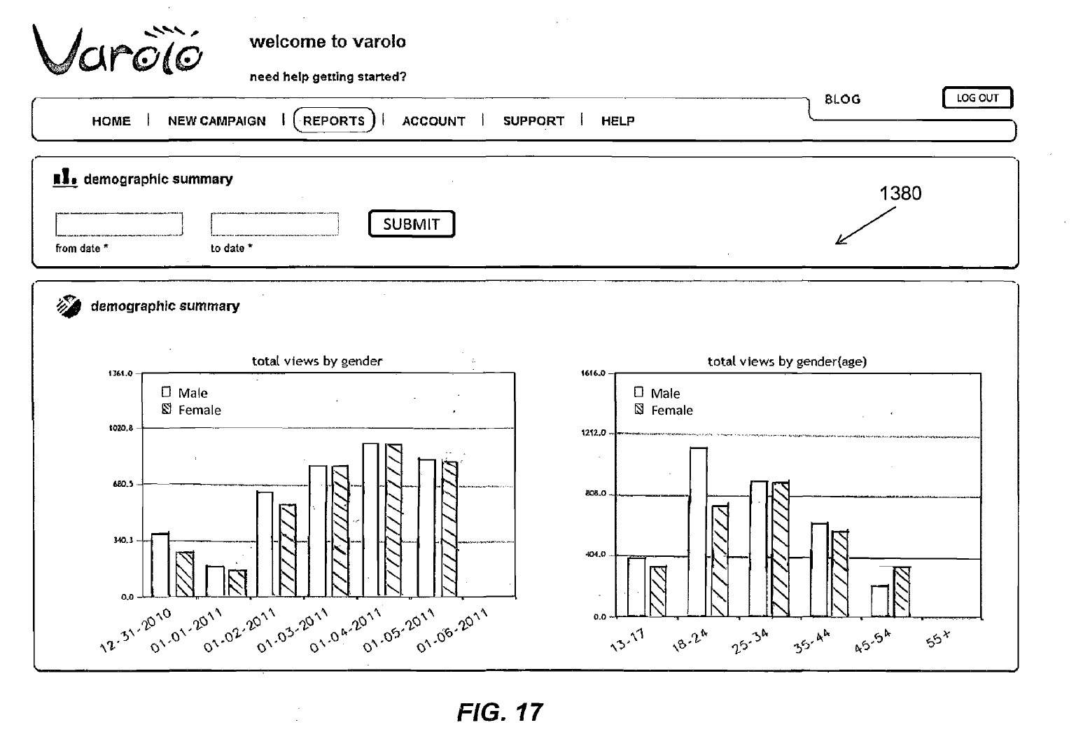

Turning now to FIG. 17, a screenshot of a reporting screen 1380 is shown. The reporting screen 1380 may show actual results and metrics of the campaign, including costs, reach, cpm and ROI.

There is thus disclosed an improved advertising incentive system and method. The various aspects of the invention may benefit advertisers by displaying their advertisements to a more targeted embodiment, providing improved feedback as to how well their advertisements are working with their intended audience, and create the potential for viral advertising success. The invention may benefit users by allowing them to view advertisements which may be viewed as being more relevant and further benefit users by providing the user with compensation, whether in the form of prizes or money for their time. It will be appreciated that numerous changes may be made to the present invention without departing from the scope of the claims.

What is claimed is:

1. An incentive system comprising:
an advertising system configured to deliver advertising to users;
a referral system configured to help users refer the advertising system to other users;
a reward system comprising:
a referral reward system configured to provide a secondary reward to a first user when a second user participates in viewing advertising due to a referral from the first user.

2. The incentive system of claim 1, wherein the first user is not a natural person.

3. The incentive system of claim 1, wherein the reward system further comprises an advertising reward system configured to provide a reward to the first user who participates in viewing advertising.

4. The incentive system of claim 1, further comprising a jackpot service providing rewards for the reward system.

5. The incentive system of claim 1, further comprising a rewards store configured to allow one or more of the users to place an order for products or services based on the value of the rewards earned.

6. The incentive system of claim 1, further comprising a verification engine configured to determine if the second user had viewed the advertisement.

7. The incentive system of claim 6, wherein the verification engine further comprises a verification method selected from the group of CAPTCHA, visual question, audio question, and a request to click on a particular area of the screen.

8. The incentive system of claim 1, wherein the system comprises demographic information regarding a plurality of users and wherein the system is configured to display advertisements to each user at least in part on demographic information for that user.

9. The incentive system of claim 1, further comprising a location detection system to report the location of a user to the advertising system.

10. The incentive system of claim 9, further comprising a notification system configured to deliver an advertisement to users near a location.

11. The incentive system of claim 10, wherein the notification system receives configuration as to allowable times of day the advertisement may be sent to users.

12. The incentive system of claim 10, wherein the advertisement is a coupon.

13. The incentive system of claim 12, further comprising a saved value system configured to store the coupon.

14. An advertising system comprising:
a user interface;
an advertiser interface;
an administrative interface;
an advertising module configured to receive advertiser requests and data from the advertiser interface;
a user module configured to receive information and requests from users, and further configured to provide advertisements to users based on the information in the advertising module; and
a financial module configured to store rewards based on user participation in the advertising; and
an administrative interface configured to provide information relating to the other modules and interfaces.

15. The advertising system of claim 14, further comprising a mobile device configured to access the user interface.

16. The advertising system of claim 14, further comprising a social discount module configured to provide a second larger discount to a user when a first discount is shared by a user.

17. An advertising system comprising:
a computer database comprising a plurality of advertisements;
a computer database having demographic information about a plurality of users;
a device for delivering advertisements to a user, the device being operatively connected to the computer database comprising a plurality of advertisements and the computer database having demographic information about a plurality of users;
means for conveying advertising targeted to a particular user to the device based on demographic information of the user; and
a database for crediting the user with a portion of proceeds obtained for showing the advertisement.

18. A computer readable medium programmed having a program disposed thereon that, when executed performs one or more operations to formulate a computerized presentation of advertisements to a user and for providing a reward to the user for viewing the advertisement, the program having a payment module, information module and demographic target data module.

19. The computer readable medium of claim 18, wherein the payment module includes information for payment in the form of a sweepstakes holdback reserved for a sweepstakes jackpot.

20. The computer readable medium of claim 18, wherein the payment module includes information of payment to be paid to users who watch an advertisement displayed by the program.
